(19) United States
(12) Patent Application Publication
(10) Pub. No.: US 2007/0124448 A1
(43) Pub. Date: May 31, 2007

(54) DEVICE AND SERVICE MANAGEMENT METHODS AND SYSTEMS

(75) Inventor: Chih Lin Hu, Tainan City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/564,218

(22) Filed: Nov. 28, 2006

(30) Foreign Application Priority Data
Nov. 30, 2005 (TW) TW94142046

(51) Int. Cl. G06F 15/16

(52) U.S. Cl. 709/223; 709/245

(57) ABSTRACT

A method for device and service management comprises the following steps. A first instant and a valid duration corresponding to an advertisement message comprising information regarding a device or a service therein are provided. The advertisement message is received at the first instant. A second instant is determined to be the first instant plus the valid duration. A third instant is determined between the first instant and the second instant. A first search message is transmitted at the third instant. It is determined whether the device or the service therein is still alive by checking if a first response message corresponding to the first search message is received.

### BACKGROUND

The present invention relates to device or service management, and more particularly, to device and service management methods and systems in a network.

UPnP architecture defines two device categories: control points (CPs) and controlled devices (simply called devices). A controlled device functions in the role of server, offering services that can be monitored or controlled by a CP, in response to requests from CPs. Protocols are supported for six function layers, addressing, discovery, description, control, eventing and presentation. Messages are hosted in UPnP-specific protocols such as Simple Service Discovery Protocol (SSDP), General Event Notification Architecture (GENA), Simple Object Access Protocol (SOAP), and are delivered by Hypertext Transform Protocol (HTTP) with its protocol extensions, e.g. HTTP multicast or unicast over UDP. All messages are delivered over Internet Protocol (IP).

The discovery layer is briefly described in the following. Discovery function is designed on the basis of SSDP by which a device sends its device and service advertisement messages, search messages and response messages. The discovery layer is where CPs search for UPnP devices on the network or UPnP devices advertise their presence. When a device is added to a network, it advertises its presence by sending message using HTTP multicast over UDP (HTTPMU). A CP will answer with a message using HTTP unicast over UDP (HTTPU).

Specifically, any UPnP device can send NOTIFY ssdp:alive message to advertise its presence at any time, and any CP sends M-SEARCH ssdp:discover message to discover all present devices and services. The periodical advertisement can also recover possible message loss due to unreliable UDP transmission. Note that this advertisement message can be cached in the local cache of the receiving devices. The cached advertisement is to be valid in the duration referring to the CACHE-CONTROL header field defined in the ssdp:alive message, that is, an HTTP/1.1 general header field. On the other hand, a CP can also multicast an M-SEARCH ssdp:discover, ST:UUID message to search for the device of UUID and to determine whether the device exists in the network or not. While the target device receives an M-SEARCH messages, it must respond to this message by sending back a message indicating its presence and valid duration before this response message expires.

The cached advertisement messages in devices, however, will be invalid when a device misfunctions between two periodical advertisement instants. FIG. 1 is a timing diagram for conventional device and service management. A CP receives an advertisement message comprising information regarding a particular UPnP device or a service therein is alive at an instant t(i). The advertisement message comprises a valid duration Sx and an instant is t(i+1)=t(i)+Sx. When the UPnP device or the service therein is unavailable at an instant t(f), for CPs, the received advertisement message is incorrect between instants t(f) and t(i+1).

### SUMMARY

Methods for device and service management are provided. An embodiment of a method comprises the following steps. A first instant and a valid duration corresponding to an advertisement message comprising information regarding a device or a service therein are provided. The advertisement message is received at the first instant. A second instant is determined to be the first instant plus the valid duration. A third instant is determined between the first instant and the second instant. A first search message is transmitted at the third instant. It is determined whether the device or the service therein is still alive by checking if a first response message corresponding to the first search message is received.

The first search message preferably an M-SEARCH request message may be transmitted over user datagram protocol (UDP). An embodiment of a method may further comprise the following steps. A second search message is transmitted via transmission control protocol (TCP) if the first response message corresponding to the first search message has not been received before a time-out of the first search message expires. It is determined whether the device or the service therein is still alive by checking if a second response message corresponding to the second search message is received.

An embodiment of a method may further comprise the following steps. It is determined that the device or the service therein is still alive if the next advertisement message is received before the second instant and before a time-out of the first search message expires.

An embodiment of a method may further comprise the following steps. When determining that the device or the service therein is still alive, the first instant is updated with an instant receiving the first response message and the valid duration is updated with a valid duration contained in the response message.

A machine-readable storage medium storing a computer program which, when executed by a control point, performs the method for device and service management is also provided.

Systems for device and service management are provided. An embodiment of a system comprises a device and a control point. The control point coupling to the device via a network provides a first instant and a valid duration corresponding to an advertisement message comprising information regarding a device or a service therein, determines a second instant being the first instant plus the valid duration, determines a third instant between the first instant and the second instant, transmits a first search message at the third instant and determines whether the device or the service therein is still alive by checking if a first response message corresponding to the first search message is received. Wherein the advertisement message is received at the first instant.

The first search message preferably an M-SEARCH request message may be transmitted over UDP. An embodiment of a control point may further transmit a second search message over transmission control protocol (TCP) if the first response message corresponding to the first search message has not been received before a time-out of the first search message expires, and determine whether the device or the service therein is still alive by checking if a second response message corresponding to the second search message is received.

An embodiment of a control point may further determine that the device or the service therein is still alive if the next advertisement message is received before the second instant and before a time-out of the first search message expires.

An embodiment of a control point, when determining that the device or the service therein is still alive, may further update the first instant with an instant receiving the first response message and update the valid duration with a valid duration contained in the response message.

The third instant may fall into a duration between the first instant and the first instant plus half of the valid duration. The advertisement message may be a NOTIFY ssdp:alive message over simple service discovery protocol (SSDP). The first search message preferably a HTTP HEAD message may be transmitted over transmission control protocol (TCP).

### BRIEF DESCRIPTION OF DRAWINGS

The invention will become more fully understood by referring to the following detailed description with reference to the accompanying drawings, wherein:

FIG. 1 is a timing diagram for conventional device and service management;

FIG. 2a is a diagram of network architecture of an embodiment of a device and service management system;

FIG. 2b is a diagram of a hardware environment applicable to an embodiment of a personal computer;

FIG. 3 is a diagram of an instant in which an exemplary advertisement message;

FIG. 4 illustrates a flowchart of an embodiment of a method for device and service management;

FIG. 5 illustrates a flowchart of an embodiment of a method for device and service management;

FIGS. 6a and 6b illustrate flowcharts of an embodiment of a method for device and service management;

FIG. 7 illustrates a flowchart of an embodiment of a method for device and service management;

FIG. 8 is a diagram of an embodiment of a storage medium storing a computer program for device and service management; and

FIGS. 9 and 10 are timing diagrams for device and service management.

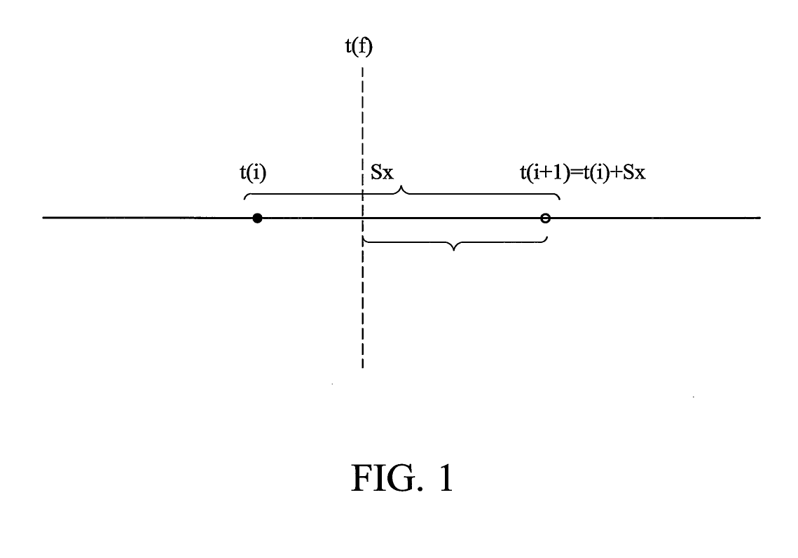

### DETAILED DESCRIPTION

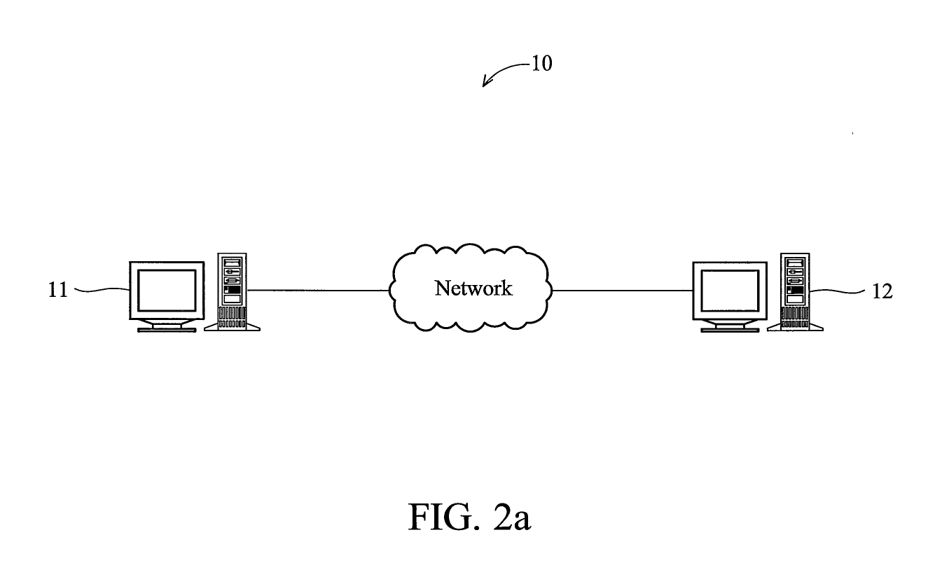

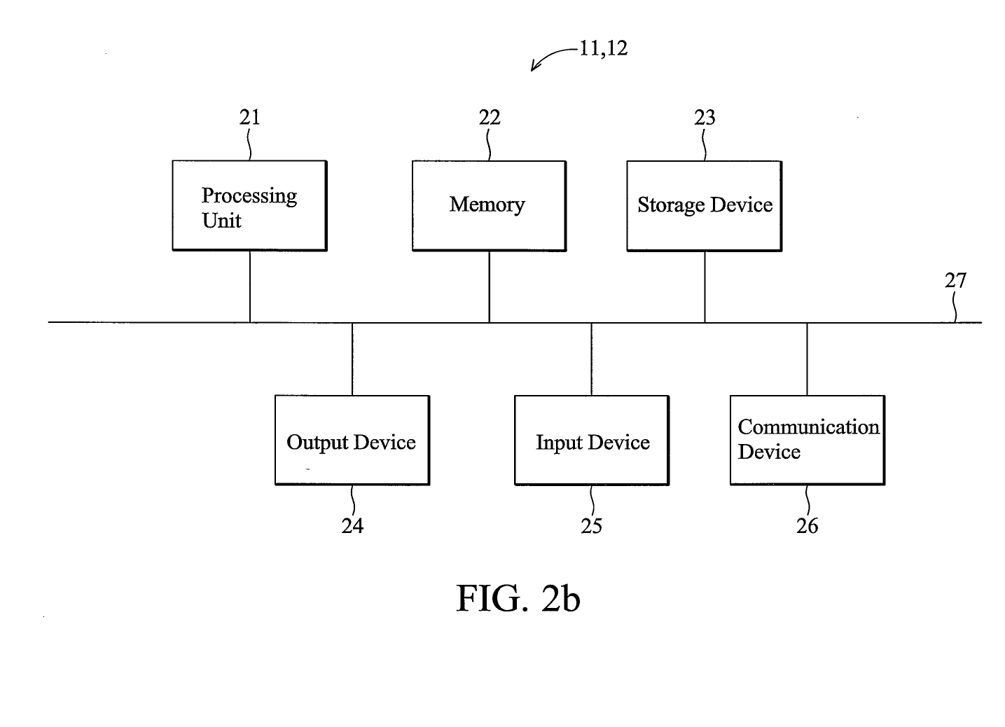

FIG. 2a is a diagram of network architecture of an embodiment of a device and service management system 10, comprising personal computers 11 and 12. The personal computer 11 operates in a network using wired, wireless or a combination thereof to connect to the personal computer 12. Those skilled in the art will recognize that the personal computers 11 and 12 may be connected in different types of networking environments, and communicate therebetween through various types of transmission devices such as routers, gateways, access points, base station systems or others.

FIG. 2b is a diagram of a hardware environment applicable to an embodiment of the personal computer 11 or 12, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 11, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform device and service management functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

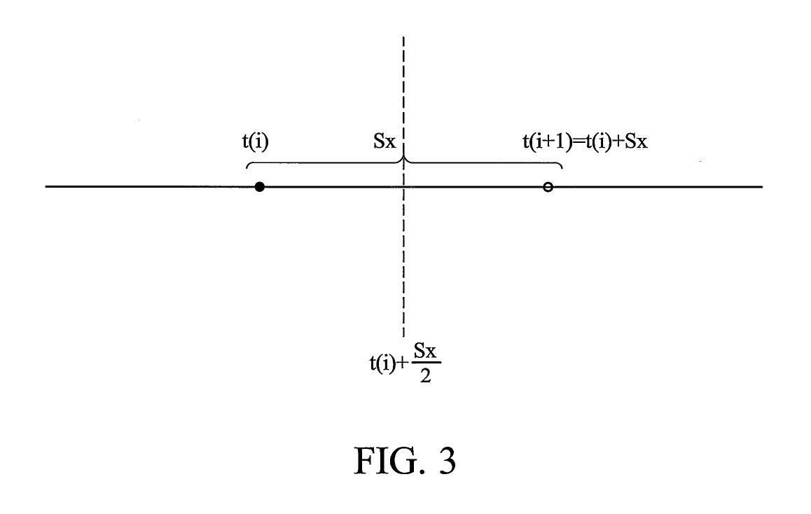

The personal computer 11 operates as a control point and the personal computer 12 operates as a controlled device (simply called device). The personal computer 12, operating as a server, provides at least one service monitored or controlled by the personal computer 11, and responds to requests issued by the personal computer 11. The personal computer 12 periodically transmits advertisement messages to the personal computer 11 to indicate its presence. FIG. 3 is a diagram of an instant for an exemplary advertisement message. The computer 11 receives an advertisement message from the computer 12 or a service therein at an instant t(i), the received message comprising information regarding that the computer 12 or a service therein is alive. The advertisement message further comprises a valid duration Sx, for example, a CACHE-CONTROL header field defined in a NOTIFY ssdp:alive message (compatible with Simple Service Discovery Protocol, SSDP) comprises a valid duration Sx. An instant is t(i+1)=t(i)+Sx. A record corresponding to the computer 12 or a service therein comprises instants t(i) and t(i+1) for the current advertisement message and is stored in the memory 22 or storage device 23. Those skilled in the art will realize the record in a file management system, database management system, data object management or cache space management system.

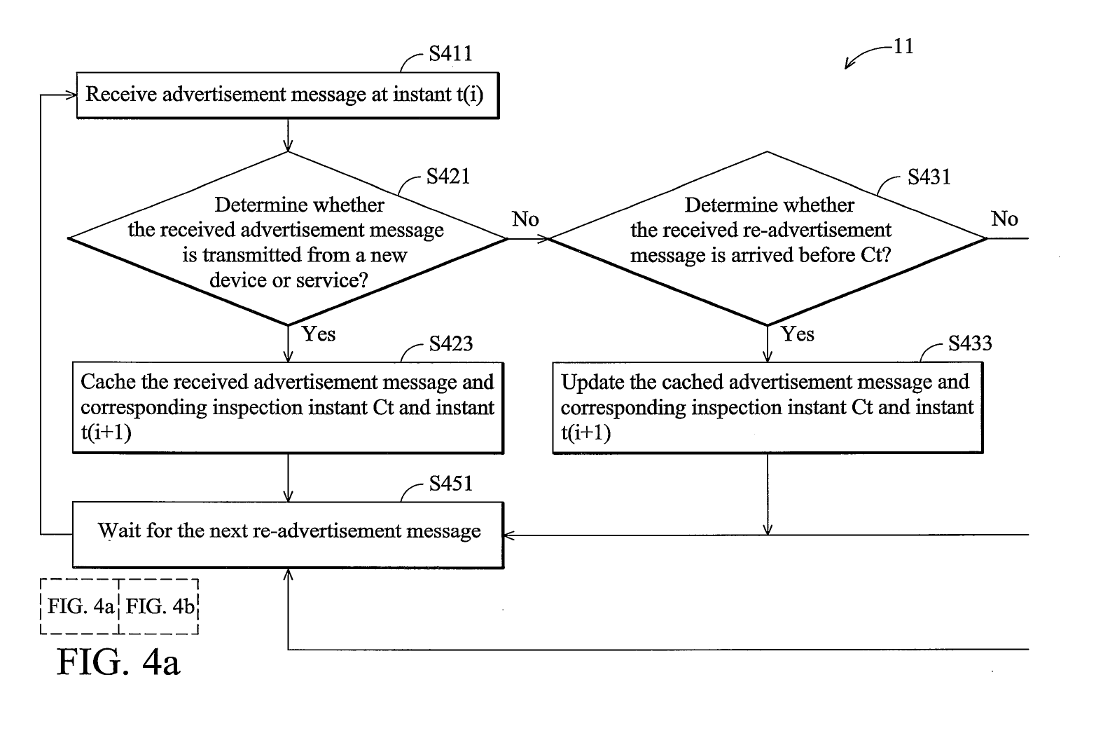

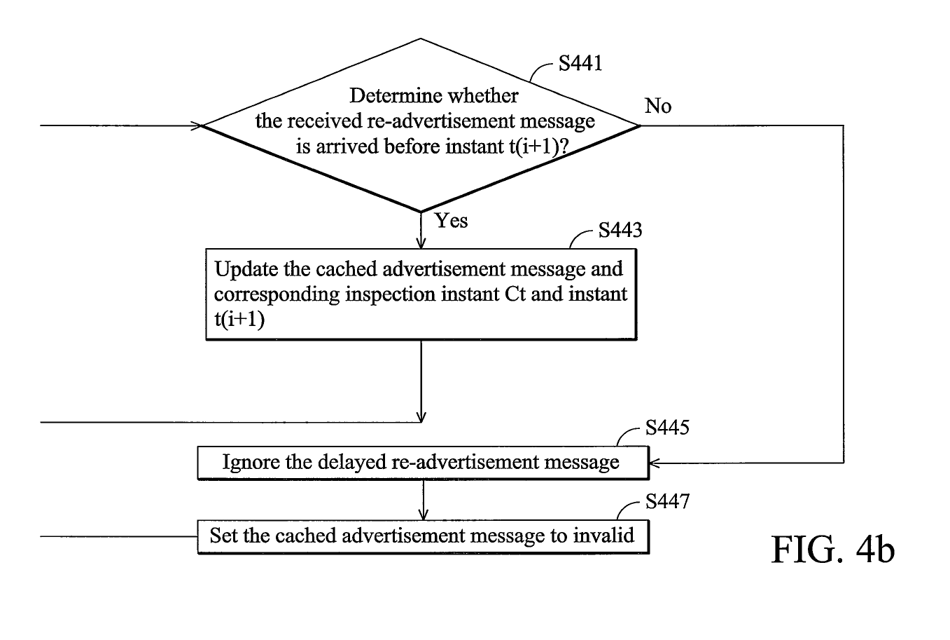

FIG. 4 illustrates a flowchart of an embodiment of a method for device and service management, showing steps performed by the personal computer 11, to perform subsequent processes after receiving an advertisement message corresponding to the personal computer 11 or a particular service therein.

In step S411, an advertisement message is received at an instant t(i). In step S421, it is determined whether the received advertisement message is transmitted from a new device or service. If so, the process proceeds to step S423, and otherwise, proceeds to step S431. Step S421 may detect whether a prior advertisement message corresponding to the received advertisement message has been stored in the memory 22 or storage device 23, wherein the received advertisement message may be referred to as re-advertisement message, and, if not, determine the received advertisement message is transmitted from a new device or service. In step S423, the received advertisement message is cached and an inspection instant Ct and an instant t(i+1) corresponding to the received advertisement message are determined and cached.

In step S431, an inspection instant Ct is provided and it is determined whether the received re-advertisement message is arrived before Ct corresponding to the prior advertisement message. If so, the process proceeds to step S433, and otherwise, proceeds to step S441. In step S433, the cached advertisement message is updated and an inspection instant Ct and an instant t(i+1) corresponding to the received re-advertisement message are determined and updated.

In step S441, it is determined whether the received re-advertisement message is arrived before an instant t(i+1) corresponding to the prior advertisement message. In step S443, the cached advertisement message is updated and an inspection instant Ct and an instant t(i+1) corresponding to the received re-advertisement message are determined and updated. In step S445, the delayed re-advertisement message is ignored. In step S447, the cached advertisement message is set to invalid. In step S451, waits for the next re-advertisement message.

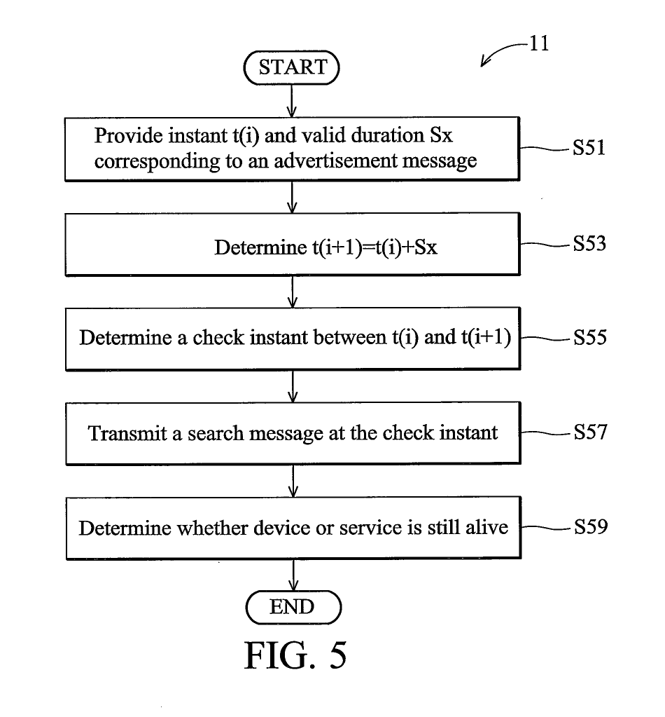

FIG. 5 illustrates a flowchart of an embodiment of a method for device and service management, showing steps performed by the personal computer 11, to periodically inspect whether the personal computer 12 or the provided service therein is available.

In step S51, an instant t(i) and a valid duration Sx corresponding to an advertisement message are provided. The advertisement message comprises information indicating the personal computer 11 or a service therein is available. The advertisement message is received at the instant t(i). In step S53, it is determined t(i+1)=t(i)+Sx. In step S55, a check instant is determined between t(i) and t(i+1). In step S57, a search message is transmitted at the check instant. In step S59, it is determined whether the personal computer 11 or the service therein is still alive by checking if a response message corresponding to the search message is received

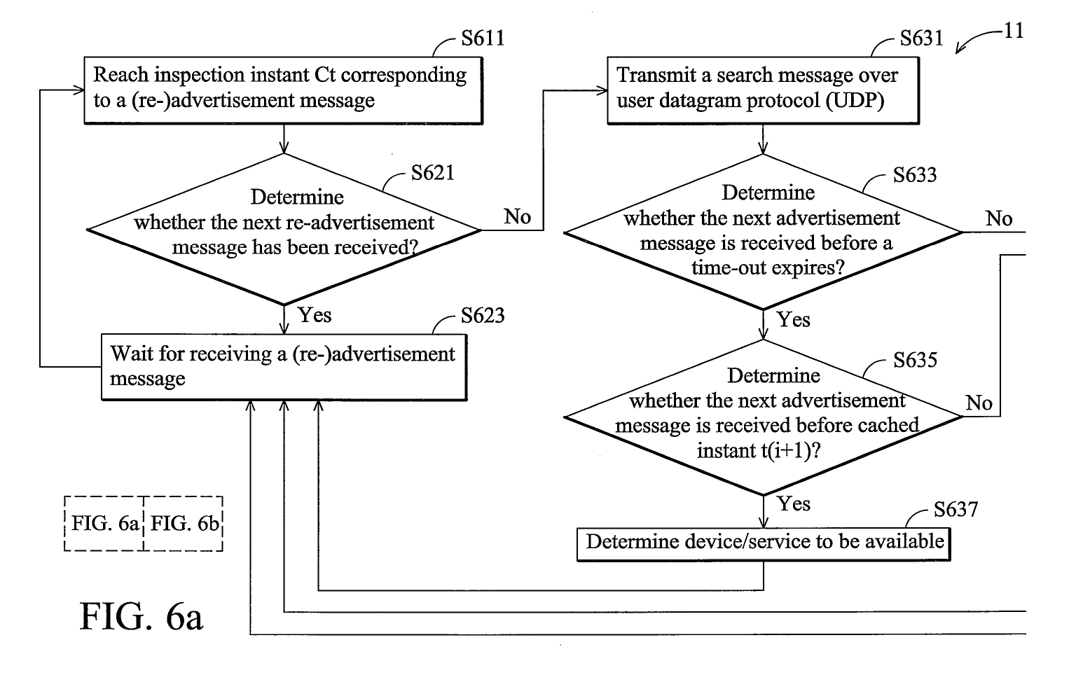

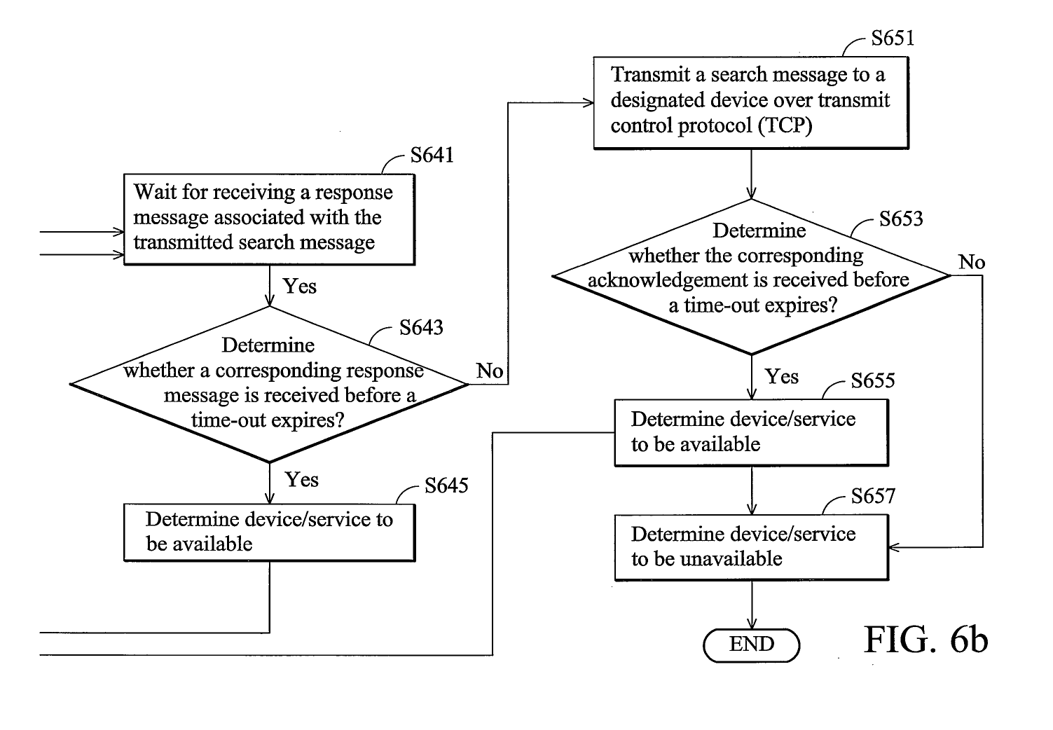

FIGS. 6a and 6b illustrate flowcharts of an embodiment of a method for device and service management, showing steps performed by the personal computer 11, to periodically inspect whether the personal computer 12 or the provided service therein is available.

In step S611, an inspection instant Ct corresponding to a (re-)advertisement message is reached. In step S621, it is determined whether the next re-advertisement message has been received. If so, the process proceeds to step S623, and otherwise, proceeds to step S631. In step S623, waits for receiving a (re-)advertisement message.

In step S631, a search message is transmitted to the personal computer 12 over user datagram protocol (UDP) to query whether the personal computer 12 or the service therein is available. Preferably, the search message is an M-SEARCH request message, and the ST field therein comprises UUID:device-uuid presenting the personal computer 12 or a particular service therein. As the personal computer 12 or a particular service therein is present in the network, the personal computer 12 or a particular service therein will ideally reply with a response message after the M-SEARCH request message is received. In step S633, it is determined whether the next advertisement message is received before a time-out expires. If so, the process proceeds to step S635, and otherwise, proceeds to step S641. In step S635, it is determined whether the next advertisement message is received before a cached instant t(i+1). If so, the process proceeds to step S637, and otherwise, proceeds to step S641. In step S637, the personal computer 12 or a particular service therein is determined to be available. Step S637 may update a record corresponding to the personal computer 12 or a particular service therein and stored in the memory 22 or storage device 23, set an instant t(i) to an instant recently receiving the advertisement message, and set an instant t(i+1)=t(i)+Sx, Sx representing a valid duration for the received advertisement message. As well as, a response message corresponding to the search message transmitted in step S631 will be ignored. Note that steps S633 to S637 deals with a situation that the next advertisement message is received from the personal computer 12 or a particular service therein before a corresponding response message is received.

In step S641, the personal computer 11 waits for receiving a response message associated with the transmitted search message. In step S643, it is determined whether a corresponding response message is received before a time-out expires. If so, the process proceeds to step S645, and otherwise, proceeds to step S651. In step S645, the personal computer 12 or a particular service therein is determined to be available. Step S645 may update a record corresponding to the personal computer 12 or a particular service therein and stored in the memory 22 or storage device 23, set an instant t(i) to an instant recently receiving the response message, and set an instant t(i+1)=t(i)+Sx, Sx representing a valid duration contained in a CACHE-CONTROL field of the recently received response message.

A response message associated with a search message may be loss during the transmission over UDP, a connectionless protocol. Thus, steps S651 and S657 further perform advertisement message inspection via transmission control protocol (TCP), a connection-oriented protocol. In step S651, a search message is transmitted to the personal computer 12 over TCP to query whether the personal computer 12 or the service therein is available. Preferably, the search message is a HTTP HEAD request message comprising a network address of the personal computer 12. If the personal computer 12 or a particular service therein present in the network, the personal computer 12 or a particular service therein will ideally reply with an acknowledgement after the HTTP HEAD request message is received. In step S653, it is determined whether the corresponding acknowledgement (also called the response message) is received before a time-out expires. If so, the process proceeds to step S655, and otherwise, proceeds to step S657. In step S655, the personal computer 12 or a particular service therein is determined to be available. Step S655 may update a record corresponding to the personal computer 12 or a particular service therein and stored in the memory 22 or storage device 23, set an instant t(i) to an instant recently receiving the acknowledgement, and set an instant t(i+1)=t(i)+Sx, Sx representing a valid duration contained in a CACHE-CONTROL field of the recently received acknowledgement. In step S657, the personal computer 12 or a particular service therein is determined to be unavailable. Step S657 may delete a record corresponding to the personal computer 12 or a particular service therein and stored in the memory 22 or storage device 23, resulting in the personal computer 11 unable to perform subsequent inspection for the personal computer 12 or a particular service therein.

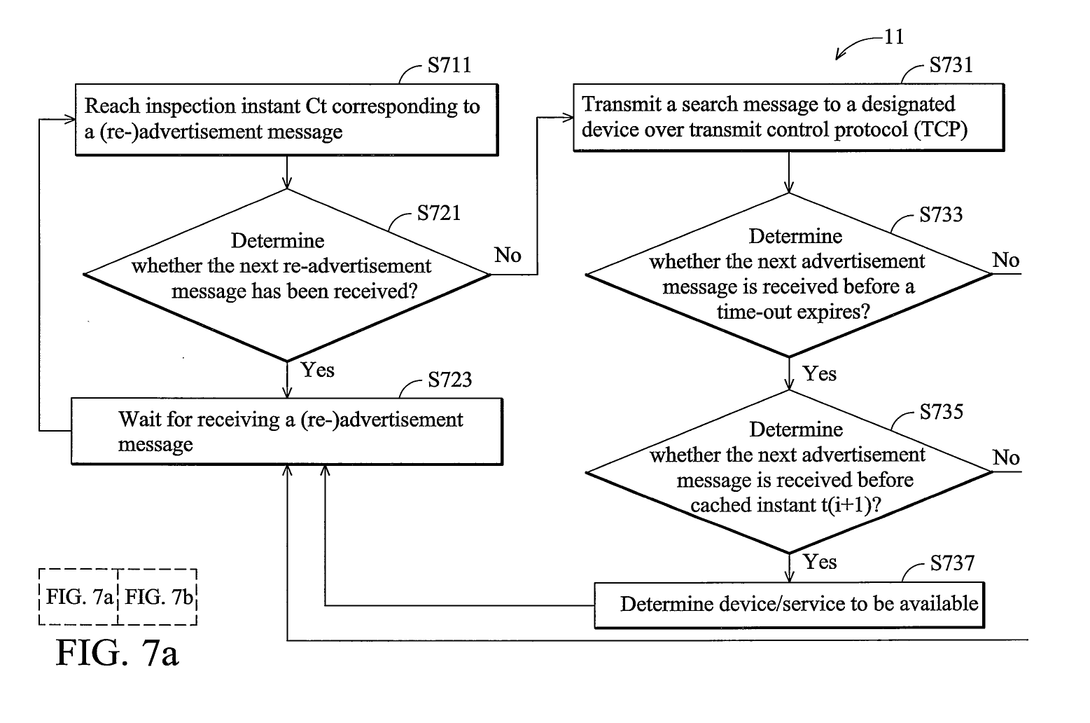

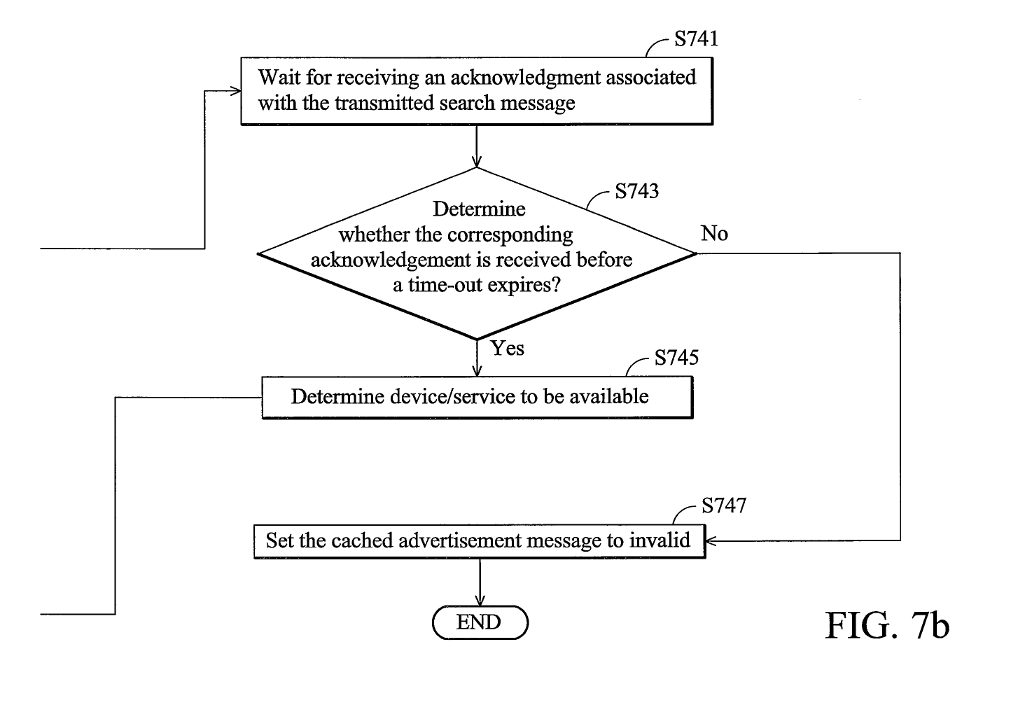

FIG. 7 illustrates a flowchart of an embodiment of a method for device and service management, showing steps performed by the personal computer 11, to periodically inspect whether the personal computer 12 or the provided service therein is available.

In step S711, an inspection instant Ct corresponding to a (re-)advertisement message is reached. In step S721, it is determined whether the next re-advertisement message has been received. If so, the process proceeds to step S723, and otherwise, proceeds to step S731. In step S723, waits for receiving a (re-)advertisement message.

In step S731, a search message is transmitted to the personal computer 12 over TCP to query whether the personal computer 12 or the service therein is available. The details of this step may refer to the description of step S651. In step S733, it is determined whether the next advertisement message is received before a time-out expires. If so, the process proceeds to step S735, and otherwise, proceeds to step S741. In step S735, it is determined whether the next advertisement message is received before a cached instant t(i+1). If so, the process proceeds to step S737, and otherwise, proceeds to step S741. In step S737, the personal computer 12 or a particular service therein is determined to be available. The details of this step may refer to the description of step S637. Note that steps S733 to S737 deals with a situation that the next advertisement message is received from the personal computer 12 or a particular service therein before a corresponding acknowledgement is received.

In step S741, the personal computer 11 waits for receiving an acknowledgement (also called a response message) associated with the transmitted search message. In step S743, it is determined whether a corresponding acknowledgement is received before a time-out expires. If so, the process proceeds to step S745, and otherwise, proceeds to step S747. In step S745, the personal computer 12 or a particular service therein is determined to be available. The details of this step may refer to the description of step S655. In step S747, the personal computer 12 or a particular service therein is determined to be unavailable. The details of this step may refer to the description of step S657.

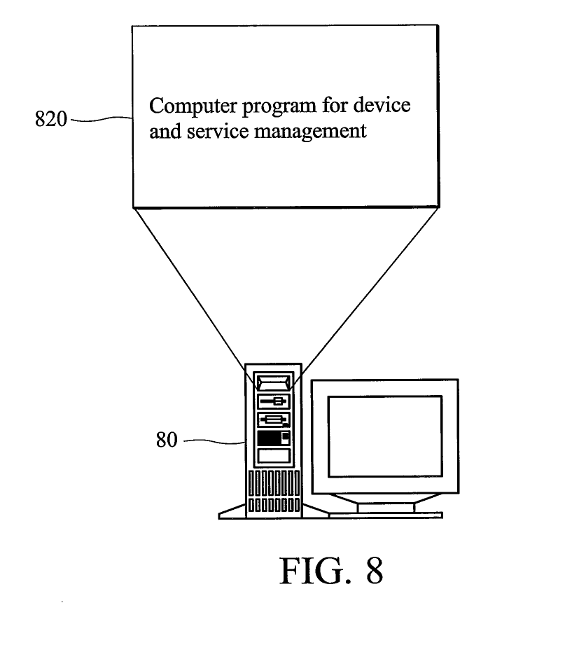

Also disclosed is a storage medium as shown in FIG. 8 storing a computer program 820 providing the disclosed methods of device and service management. The computer program includes a storage medium 80 having computer readable program code therein for use in a computer system. The computer readable program code comprises computer logic described in FIGS. 4 to 7.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

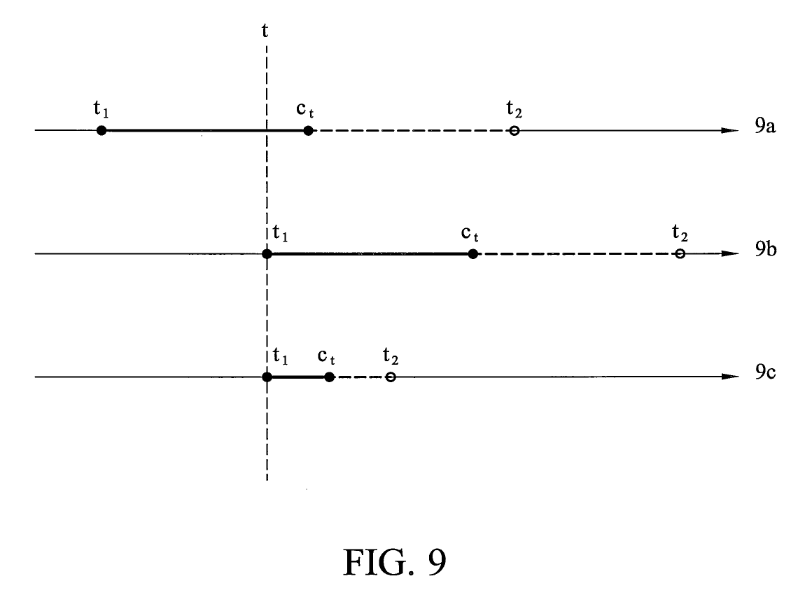

Details of the methods of device and service management are further illustrated in the following examples. FIG. 9 is a timing diagram for device and service management. Referring to a time line 9a, the personal computer 11 receives an advertisement message from the computer 12 or a particular service therein at an instant t between instances t1 and Ct. Referring to the methods described in FIG. 4, the computer 11 considers that the computer 12 or the service therein is still present in the network, and updates a corresponding instant t2 with t2=t+Sx (referring to FIG. 3) and an inspection instant Ct with Ct=t1+Sx/2. Time lines 9b and 9c illustrate two different results after updating. It will be understood that the valid duration Sx contained in the re-advertisement message may equal or differ the previous cached valid duration.

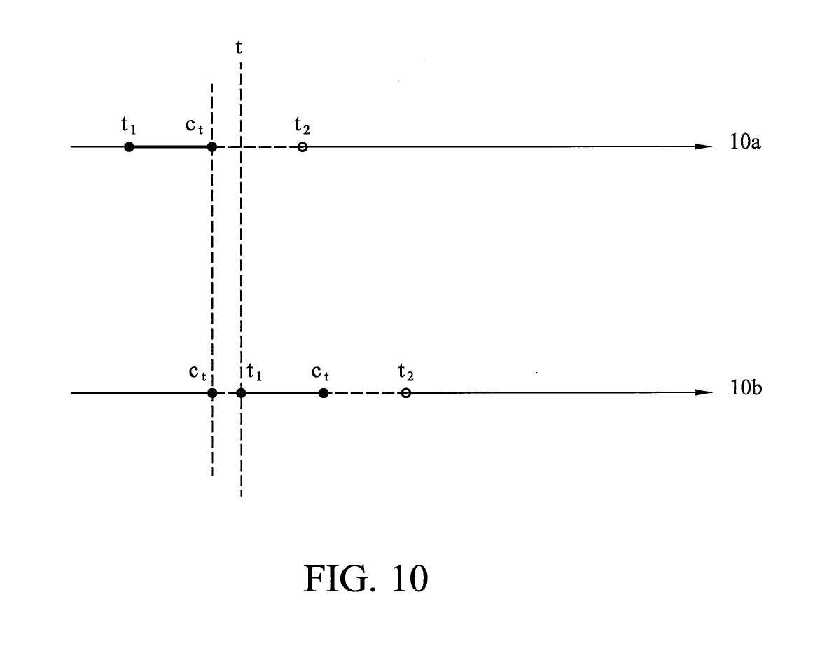

FIG. 10 is a timing diagram for device and service management. Referring to a time line 10a, the personal computer 11 transmits a search message (over UDP or TCP) to the computer 12 or a particular service therein at an inspection instant Ct, and receives a re-advertisement message or a response message corresponding to the transmitted search message from the computer 12 or a particular service therein at an instant t between instances Ct and t2. Referring to the methods described in FIG. 5, 6 or 7, the computer 11 considers that the computer 12 or the service therein is still present in the network, and updates a corresponding instant t2 with t2=t+Sx (referring to FIG. 3) and an inspection instant Ct with Ct=t1+Sx/2. A time line 10b illustrates a result after updating. It will be understood that the valid duration Sx contained in the re-advertisement message or response message may equal or differ the previous cached valid duration.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method for device and service management, performed by a control point, comprising:
providing a first instant and a valid duration corresponding to an advertisement message comprising information regarding a device or a service therein, the first instant being an instant receiving the advertisement message;
determining a second instant being the first instant plus the valid duration;
determining a third instant between the first instant and the second instant;
transmitting a first search message at the third instant; and
determining whether the device or the service therein is still alive by checking if a first response message corresponding to the first search message is received.

2. The method as claimed in claim 1 wherein the third instant further falls into a duration between the first instant and the first instant plus half of the valid duration.

3. The method as claimed in claim 1 wherein the first search message is transmitted over user datagram protocol (UDP).

4. The method as claimed in claim 3 wherein the first search message is an M-SEARCH request message.

5. The method as claimed in claim 4 further comprising:
transmitting a second search message over transmission control protocol (TCP) if the first response message corresponding to the first search message has not been received before a time-out of the first search message expires; and
determining whether the device or the service therein is still alive by checking if a second response message corresponding to the second search message is received.

6. The method as claimed in claim 1 wherein the advertisement message is a NOTIFY ssdp:alive message over simple service discovery protocol (SSDP).

7. The method as claimed in claim 1 wherein the first search message is transmitted over transmission control protocol (TCP).

8. The method as claimed in claim 7 wherein the first search message is a HTTP HEAD message.

9. The method as claimed in claim 1 further comprising determining that the device or the service therein is still alive if the next advertisement message is received before the second instant and before a time-out of the first search message expires.

10. The method as claimed in claim 1 further comprising, when determining that the device or the service therein is still alive, updating the first instant with an instant receiving the first response message and updating the valid duration with a valid duration contained in the response message.

11. A machine-readable storage medium for storing a computer program which, when executed by a control point, performs a method for device and service management, the method comprising:
providing a first instant and a valid duration corresponding to an advertisement message comprising information regarding a device or a service therein, the first instant being an instant receiving the advertisement message;
determining a second instant being the first instant plus the valid duration;
determining a third instant between the first instant and the second instant;
transmitting a first search message at the third instant; and
determining whether the device or the service therein is still alive by checking if a first response message corresponding to the first search message is received.

12. A system for device and service management comprising:
a device; and
a control point coupling to the device via a network, providing a first instant and a valid duration corresponding to an advertisement message comprising information regarding a device or a service therein, determining a second instant being the first instant plus the valid duration, determining a third instant between the first instant and the second instant, transmitting a first search message at the third instant and determining whether the device or the service therein is still alive by checking if a first response message corresponding to the first search message is received,
wherein the advertisement message is received at the first instant.

13. The system as claimed in claim 12 wherein the third instant further falls into a duration between the first instant and the first instant plus half of the valid duration.

14. The system as claimed in claim 12 wherein the first search message is transmitted over user datagram protocol (UDP).

15. The system as claimed in claim 14 wherein the first search message is an M-SEARCH request message.

16. The system as claimed in claim 15 wherein the control point transmits a second search message over transmission control protocol (TCP) if the first response message corresponding to the first search message has not been received before a time-out of the first search message expires, and determines whether the device or the service therein is still alive by checking if a second response message corresponding to the second search message is received.

17. The system as claimed in claim 12 wherein the advertisement message is a NOTIFY ssdp:alive message over simple service discovery protocol (SSDP).

18. The system as claimed in claim 12 wherein the first search message is transmitted over transmission control protocol (TCP).

19. The system as claimed in claim 12 wherein the control point determines that the device or the service therein is still alive if the next advertisement message is received before the second instant and before a time-out of the first search message expires.

20. The system as claimed in claim 12 wherein the control point, when determining that the device or the service therein is still alive, updates the first instant with an instant receiving the first response message and updates the valid duration with a valid duration contained in the response message.
